(19) United States
(12) Patent Application Publication
(10) Pub. No.: US 2006/0180757 A1
(43) Pub. Date: Aug. 17, 2006

(54) Method for determining concentration profiles from infrared profiles and from HPLC data

(75) Inventors: Helene Nogent, Genay (FR); Jacques Lagouardat, Noisy Le Grand (FR)

Correspondence Address: ROSS J. OEHLER;SANOFI-AVENTSI U.S. LLC, 1041 ROUTE 202-206, MAIL CODE: D303A, BRIDGEWATER, NJ, 08807, US

(73) Assignee: sanofi-aventis, Antony (FR)

(21) Appl. No.: 11/343,162

(22) Filed: Jan. 30, 2006

Related U.S. Application Data
(63) Continuation of application No. 10/452,412, filed on Jun. 2, 2003.

(30) Foreign Application Priority Data
Jun. 3, 2002 (FR) FR 0206781

(51) Int. Cl. G01J 5/00

(52) U.S. Cl. 250/338.1

(57) ABSTRACT

Method which makes it possible to define, over time, the concentration of the species in a reaction medium from the infrared profiles of the products resulting from the monitoring of the reaction and from the HPLC data, without precalibration of the devices.

### CROSS-REFERENCE TO RELATED APPLICATION

This application is a continuation of application Ser. No. 10/452,4127 filed Jun. 2, 2003, which application is, which claims the benefit of French Application No. 0206781, filed Jun. 3, 2002.

### SUMMARY OF THE INVENTION

The present invention relates to a method for determining the concentration profiles of all the species present in the same solution without precalibration of the measuring devices. A device based on the principle of InfraRed (IR) spectrometry and any other technique for analysis proportional to the concentration, such as, for example, HPLC (high performance liquid chromatography), are generally used. This method can be used to determine the kinetics of a reaction and to quantitatively determine the various entities formed.

This method makes it possible to rapidly obtain a quantitative profile of all the species present without preliminary standardization (E or HPLC) and to obtain the UV (ultraviolet) response coefficients of each species without it being necessary to have isolated them (that is to say, statistically), and makes it possible to determine a model relating the IR absorbance and the concentration for each product, taking into account the experimental error

### BACKGROUND OF THE INVENTION

Currently, to obtain quantitative results from infrared data, it is necessary to calibrate the infrared by acquisition of the IR spectra of various standard mixtures after deconvolution of the signal. As regards the HPLC, to obtain a quantitative view of the reaction, it is necessary to determine the UV response coefficients of the visible compounds by a plot of the UV response curves.

The technique according to the invention makes it possible to derive the maximum information from these two analytical methods it can be applied to any method for the “on-line” determination of a measurement proportional to the concentration as a function of the time which makes it possible to obtain a large amount of data but for which the proportionality coefficient with respect to the concentration is unknown.

### BRIEF DESCRIPTION OF THE DRAWINGS

FIG. 1 is a graph of the infrared data of the example.

FIG. 2 is a graph showing the concentration profile obtained by correlating the HPLC points and the infrared profiles of the example.

### DETAILED DESCRIPTION OF THE INVENTION

An embodiment of the invention is a statistical method which makes it possible to extract quantitative data from two series of qualitative analyses. In studies carried out previously, the Applicant Company found that, in the method for determining the concentration profiles from the IR data and from an external calibration, the material balance was not always obeyed. This might be due to poor HPLC standardization or to IR measurements biased by a non-zero residual absorbance, for example.

The method developed makes it possible to obtain a concentration profile for all the species without preliminary standardization (IR or analogous method, and HPLC), to obtain the UV response coefficients of each species without isolating them and to determine a model relating the IR (or other) absorbance and the concentration for each product.

An embodiment of this invention is a method for determining the concentrations of the species in the medium, characterized by the measurement of infrared spectra as a function of the time and of a second measurement from a technique for analysis proportional to the concentration of the species in the medium. The method according to the invention thus makes it possible to more rapidly obtain the data necessary for the determination of a kinetic profile.

The method according to the invention for determining the concentrations of the species in the medium is characterized by the determination in the medium of the infrared and HPLC proportionality coefficients.

The method according to the invention, where the concentration of the species is determined by the infrared and HPLC profiles, is characterized in that no precalibration of the HPLC and on line infrared devices is carried out.

That is to say that the proportionality coefficients of the infrared signal and of the HPLC signal of each product with respect to the concentration are unknown. Only the number of compounds identified by infrared is known.

An embodiment of the invention is the use of online infrared spectrometry devices, of infrared spectrometry deconvolution software and of an HPLC device for carrying out the analytical method.

Another embodiment of the invention is the use of on-line infrared spectrometry devices and of infrared spectrometry deconvolution software for carrying out the analytical method.

Another embodiment of the invention is the use of a measuring device which makes it possible to obtain a profile related to the concentration and the time for carrying out the analytical method.

Another embodiment of the invention is the use of an HPLC device for carrying out the analytical method.

It is appreciated that certain features of the invention, which are, for clarity, described in the context of separate embodiments, may also be provided in combination in a single embodiment. Also, various features of the invention which are, for brevity, described in the context of a single embodiment, may also be provided separately or in any suitable subcombination.

This method is illustrated, in a nonlimiting way, with regard to a conventional reaction for the esterification of benzoic acid to ethyl benzoate in an acid medium. This chemical reaction was monitored by two on line analytical techniques: Fourrier transform infrared (FTIR) and high performance liquid chromatography (HPLC). These two series of analyses make it possible to separately obtain “qualitative” analyses (change from one product with respect to another, non-change, end of reaction). As a result of the large amount of redundant data resulting from the two analytical series, and after having identified by HPLC the products detected in IR it is possible to calculate the proportionality coefficients with respect to the concentration. By combining these results, it was then possible to obtain the conversions in real time, the residual concentration of starting material and the UV response coefficients of each product. Kinetic monitoring could be carried out and the kinetic model validated.

This method makes it possible to make use, in a detailed way, of the two types of analysis and to obtain more information by combining them than each taken separately, that is to say to determine the proportionality coefficients (the statistical UV response coefficient for each product in solution and the parameters of the model relating the IR absorbance and the concentration of each of the species).

This technique requires that each of the compounds identified in infrared be simultaneously visible in HPLC.

To use this method, it is necessary to have each product detected in infrared associated with a product detected in HPLC. It is also necessary to take a certain number of HPLC (or another quantitative analytical technique) samples, so as to have the data necessary for the mathematical resolution of the problem, that is to say to have the data necessary for the determination of the 4 parameters: 3 infrared parameters and 1 HPLC parameter per product. The ideal is to take a number of samples which is 2 times greater than that of the number of products observed.

The principle of the programme is based on the comparison of all the signals recorded for each product and of the total signal. These responses are reworked mathematically by employing the response coefficients and by using a simple model of proportionality between the absorbance measured and the concentration while obeying the equations of the material balance at each instant t and observing the identity of the results obtained for each analytical series.

This mathematical manipulation makes it possible to thus obtain, at each instant t, the identity of the results resulting from the various analytical systems for each of the products at each instant and the identity of the total signal.

That is to say that, for each product, at each instant t, the reworked results resulting from the HPLC and those resulting from the infrared have to be identical and that the sum of these results must itself also be identical. That is to say, for a reaction where three products are present in the medium:

Concentration product 1 HPLC (for each sample taken)=Concentration product 1 Infrared

Concentration product 2 HPLC (for each sample taken)=Concentration product 2 Infrared

Concentration product 3 HPLC (for each sample taken)=Concentration product 3 Infrared

Sum of the HPLC concentrations (for each sample taken)=Sum of the infrared concentrations

Sum of the concentrations in IR (at any instant)=material balance

The present invention is illustrated in a nonlimiting way with the following example, where three products are present in the medium.

### EXAMPLE

This method was tested on the reaction for the esterification of benzoic acid to ethyl benzoate in ethanol in the presence of sulphuric acid at 50° C. A React IR 1000 IR probe is introduced into the medium and makes it possible, after treatment by deconvolution, to obtain an absorbance profile as a function of the wavenumber and of the time. According to the Beer-Lambert law, the infrared profiles obtained are proportional to the concentration in the medium. The HPLC profile is determined by regular withdrawn samples. The HPLC device is composed of an Inertsil ODS column with a length L=25 cm and a diameter of 4.6; wavelength 220 nm oven 30° C.; eluent 100% methanol; withdrawn sample 0.1 ml of reaction mum in 20 ml of methanol; volume injected 1 μl. This method makes it possible to obtain the UV response coefficients of the products without having to plot their HPLC calibration line and to obtain their concentrations at each instant in the medium.

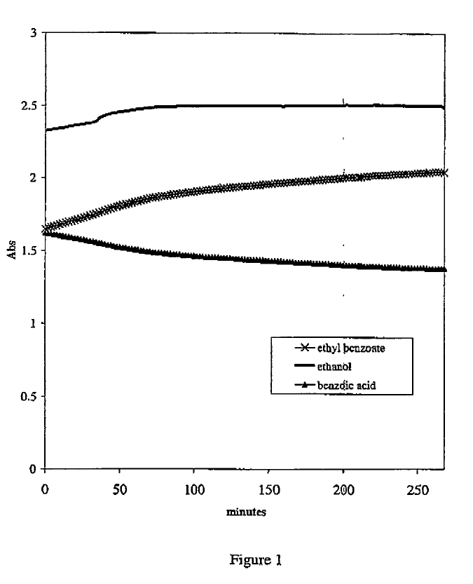

The infrared data used are represented in FIG. 1. These are the infrared profiles of the various products obtained by deconvolution of the raw infrared data; they represent the absorbance of the products as a function of the time.

The results of the HPLC measurements are given in Table 1 below.

TABLE 1

| | Area of the benzoic | Area of the ethyl |
|---|---|---|
| T (h) | acid peak (au) | benzoate peak (au) |
| 0 | 7824759.5 | 86477 |
| 0.233 | 7529081.5 | 218547 |
| 0.666 | 7237722 | 561973 |
| 4.1 | 5685246 | 2018365 |

Mathematical treatment of these infrared profiles gives the reduced IR data for the HPLC sampling times. The results are presented in Table 2.

The reduced IR data are obtained by the relationship:
Reduced Abs=(raw ABS−minimum raw ABS)/(maximum raw ABS−minimum raw ABS)

where minimum raw ABS is the minimum of the absorbance curve for the product under consideration and maximum raw ABS is the maximum of the absorbance curve for the same product.

TABLE 2

| | Reduced Abs | Reduced Abs |
|---|---|---|
| T (h) | Benzoic acid | Ethyl benzoate |
| 0 | 1 | 0 |
| 0.233 | 0.89354125 | 0.10645875 |
| 0.666 | 0.67349637 | 0.32650363 |
| 4.1 | 0 | 1 |
| Min. raw ABS | 1.382 | 1.648 |
| Max. raw ABS | 1.6204 | 2.041 |

It is then possible, from these reworked data, to calculate the UV response coefficients of benzoic acid and of ethyl benzoate (Table 3) by choosing, as simple proportionality model:
Ci=Ai×(1/Hi)

in which Ci is the molar concentration of the product i; Hi is the area/molar concentration response coefficient calculated and Ai is the area of the product i in HPLC.

TABLE 3

| Product | Statistical H | Experimental H |
|---|---|---|
| Benzoic acid | 4.55 × 10⁶ | 4.36 × 10⁶ |
| Ethyl benzoate | 4.293 × 10⁶ | 4.38 × 10⁶ |

Starting from commercial products, the values obtained for the response coefficients measured are identical to those found by the statistical method described above and which are reported in Table 3.

The coefficients of the infrared model, relating the absorbance and the concentration of the species, are then also determined.

The model relating the concentration and the absorbance is
Ciₜ=βio+βiₜ*[AbsXri]ₜ+βi₂*([AbsXri]ₜ)²
where

Ciₜ is the molar concentration of the product i in the medium at the instant t

βio, βi₁ and βi₂ are the coefficients of the correlation model for the product i

[AbsXri]ₜ is the reduced absorbance of the product i at the instant t.

The results are presented in Table 4.

TABLE 4

| Coefficient of the model | Benzoic acid | Ethyl benzoate |
|---|---|---|
| β₀ | 1.24897 | 0.0201432 |
| β₁ | 0.44988 | 0.44987 |
| β₂ | −2.6e⁻⁶ | 2.573e⁻⁶ |

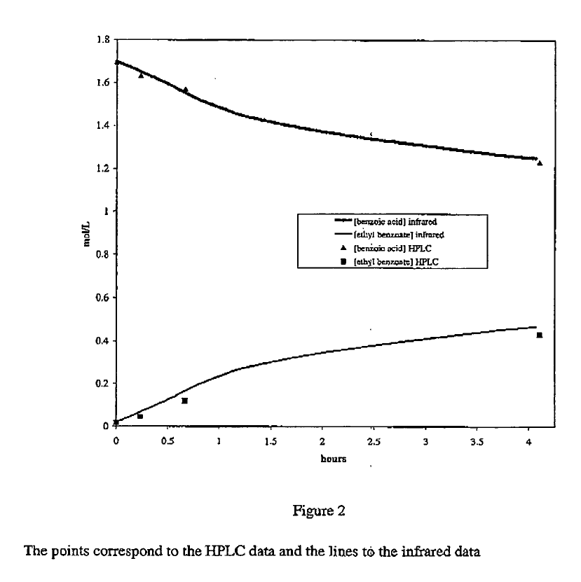

The concentration profile obtained by correlating the HPLC points and the infrared profiles is presented in FIG. 2. The residue with regard to the material balance for the infrared is 1.3×10⁻¹³ and the residue for correlation between the HPLC and infrared results is 6×10⁻⁴. The identity of the balances and of the results is therefore indeed achieved. The concentration profiles are therefore realistic.

This method has made it possible to find the relative response coefficients of the products and then to obtain a concentration profile in which the material balance is obeyed at each instant and for each series of measurements and which corresponds to the known kinetic model.

1. Method for determining the concentrations of the species in a medium by the measurement of infrared spectra as a function of the time and of a second measurement from a technique for analysis proportional to the concentration of the species in the medium, characterized by the determination in the medium of the infrared and HPLC proportionality coefficients.

2. Method for determining the concentrations of the species in a medium by the measurement of infrared spectra as a function of the time with an infrared device and of a second measurement from a technique for analysis proportional to the concentration of the species in the medium with an HPLC device, wherein the method is carried out without precalibration of the two devices.
